(19) United States
(12) Patent Application Publication
(10) Pub. No.: US 2020/0143424 A1
(43) Pub. Date: May 7, 2020

(54) INFORMATION PROCESSING APPARATUS, INFORMATION PROCESSING METHOD, AND NON-TRANSITORY STORAGE MEDIUM

(71) Applicant: TOYOTA JIDOSHA KABUSHIKI KAISHA, Toyota-shi (JP)

(72) Inventors: Tsugumi Otsuka, Nagoya-shi (JP); Kazuya Nishimura, Okazaki-shi (JP); Yuki Ito, Iwakura-shi (JP); Akio Uotani, Nagoya-shi (JP); Makoto Akahane, Nagoya-shi (JP); Wataru Shiina, Nagoya-shi (JP)

(73) Assignee: TOYOTA JIDOSHA KABUSHIKI KAISHA, Toyota-shi (JP)

(21) Appl. No.: 16/666,605

(22) Filed: Oct. 29, 2019

(30) Foreign Application Priority Data
Nov. 6, 2018 (JP) 2018-209152

(51) Int. Cl. G06Q 30/02

(52) U.S. Cl. CPC G06Q 30/0266; G06Q 30/0259

(57) ABSTRACT

Advertisement information relevant to a store or the like which newly opened is provided, while enhancing an advertisement effect thereof. An information processing apparatus comprises a controller comprising at least one processor configured to execute acquisition of advertisement information relevant to a first store which started provision of a service in a predetermined period; and display of the advertisement information of the first store while giving preference thereto as compared with advertisement information relevant to a second store other than the first store, on a display unit which is provided on a first vehicle and which displays information with respect to outside of the first vehicle.

### CROSS REFERENCE TO RELATED APPLICATION

This application claims the benefit of Japanese Patent Application No. 2018-209152, filed on Nov. 6, 2018, which is hereby incorporated by reference herein in its entirety.

### BACKGROUND

### Technical Field

The present disclosure relates to an information processing apparatus, an information processing method, and a non-transitory storage medium for a system in which a vehicle is used as a display medium for an advertisement.

### Description of the Related Art

In recent years, the information communication technique, which is available for a moving body such as a vehicle or the like, is highly sophisticated. Further, it is suggested that a moving body is utilized as a display medium for an advertisement or the like. For example, Patent Literature 1 discloses such a technique that a personal liking or taste is acquired from a following vehicle by the aid of the inter-vehicle communication, and an advertisement content, which is adapted to the liking or taste, is displayed on a back portion of a vehicle.

### PRIOR ART LITERATURE

### Patent Literature

Patent Literature 1: Japanese Patent Application Laid-Open No. 2016-66358

### SUMMARY

In the meantime, such a situation is also assumed that a young man or woman or the like, who uses the vehicle, expects information in relation to a new store, for example, an advertisement of a store or the like which newly opened in a living area of himself/herself, without being shackled by the attribute of himself/herself. In view of the above, an object of the present disclosure is to provide advertisement information relevant to a store or the like which newly opened, while enhancing an advertisement effect thereof.

One aspect of the present disclosure may be exemplified as an information processing apparatus. This information processing apparatus may comprise a controller comprising at least one processor configured to execute acquisition of advertisement information relevant to a first store which started provision of a service in a predetermined period; and display of the advertisement information of the first store while giving preference thereto as compared with advertisement information relevant to a second store other than the first store, on a display unit which is provided on a first vehicle and which displays information with respect to outside of the first vehicle.

Another aspect of the present disclosure may be exemplified as an information processing method. The present disclosure may reside in an information processing method comprising acquiring advertisement information relevant to a first store which started provision of a service in a predetermined period; and displaying the advertisement information of the first store while giving preference thereto as compared with advertisement information relevant to a second store other than the first store, on a display unit which is provided on a first vehicle and which displays information with respect to outside of the first vehicle.

Still another aspect of the present disclosure may be exemplified as a non-transitory storage medium stored with a program to be executed by a computer. The present disclosure may reside in a program for allowing a computer to execute acquisition of advertisement information relevant to a first store which started provision of a service in a predetermined period; and display of the advertisement information of the first store while giving preference thereto as compared with advertisement information relevant to a second store other than the first store, on a display unit which is provided on a first vehicle and which displays information with respect to outside of the first vehicle, or a non-transitory storage medium on which the program is stored.

According to the present disclosure, it is possible to provide the advertisement information relevant to the store or the like which newly opened, while enhancing the advertisement effect thereof.

### BRIEF DESCRIPTION OF THE DRAWINGS

FIG. 1 illustrates exemplary system configuration of an advertisement system according to a first embodiment.

FIG. 2 explains positions of display apparatuses provided on vehicles.

FIG. 3 explains selection of advertisement information.

FIG. 4 illustrates respective exemplary hardware configuration of an advertisement delivery server and vehicle onboard apparatuses.

FIG. 5 illustrates exemplary functional configuration of the vehicle onboard apparatus.

FIG. 6 illustrates exemplary functional configuration of the advertisement delivery server.

FIG. 7 illustrates exemplary user information stored in user information DB.

FIG. 8 illustrates exemplary advertisement information stored in advertisement information DB.

FIG. 9 illustrates a sequence diagram illustrating an exemplary processing procedure executed by the advertisement delivery server and the vehicle onboard apparatuses.

FIG. 10 illustrates a flow chart illustrating a detailed exemplary process of S7.

FIG. 11 illustrates a flow chart illustrating a detailed exemplary process of S8.

FIG. 12 illustrates a flow chart illustrating a detailed exemplary process of S7 in a second modified embodiment.

### DESCRIPTION OF THE EMBODIMENTS

An advertisement delivery server according to an embodiment of the present disclosure may be an information processing apparatus of an advertisement system for displaying advertisement information of a store or the like which newly opened, while enhancing an advertisement effect thereof, on a vehicle which can display information with respect to the outside of the vehicle. Those exemplified as the vehicle may include, for example, billboard trucks (advertising trucks) and public transport facilities including, for example buses and taxies each of which has a display apparatus for displaying advertisement information toward the back of the vehicle, as well as general vehicles including, for example, trucks, SUV's (Sport Utility Vehicles), and sedans. It is also possible to affirm that the user, who gets on the vehicle, is an end-user who utilizes the transfer or transport by using the vehicle, or a consumer who enjoys the service which is presented by the displayed advertisement information.

The advertisement delivery server according to the embodiment of the present disclosure may be configured such that the advertisement information, which is relevant to a first store that started the provision of a service in a predetermined period, is acquired. As for the predetermined period, a unit period of, for example, 1 month or 3 months is previously set by means of the advertisement system. Then, the advertisement delivery server may be configured such that the advertisement information of the first store is displayed, while giving preference or priority thereto as compared with the advertisement information relevant to a second store other than the first store, on a display unit which is provided on a first vehicle and which displays information with respect to the outside of the first vehicle. According to the configuration as described above, the advertisement information, which is relevant to the first store, can be displayed on the display unit of the first vehicle, while giving the preference thereto as compared with the other advertisement information. Therefore, it is possible to provide the advertisement information relevant to the store or the like which newly opened, while enhancing the advertisement effect thereof.

The advertisement delivery server may display advertisement information relevant to a third store having no record remaining in the history information relevant to the traveling of the second vehicle which chases the first vehicle, while giving preference thereto as compared with the advertisement information relevant to the second store, the third store being included in a plurality of the first stores. It is possible to provide the advertisement information relevant to the store or the like which newly opened and which has not been visited by the user of the second vehicle yet.

Further, the advertisement delivery server may acquire destination information relevant to a destination and route information relevant to a route until arrival at the destination of a second vehicle, and the advertisement delivery server may display advertisement information relevant to a fourth store in relation to the destination information and the route information, while giving preference thereto as compared with the advertisement information relevant to the second store, the fourth store being included in a plurality of the first stores. It is possible to continuously provide the advertisement information which is relevant to the store or the like that newly opened and which is adapted to the destination information (whereabouts information) of the user of the second vehicle, until arrival at the destination.

An embodiment will be explained below with reference to the drawings. The configuration of the following embodiment is shown by way of example. The mode for carrying out the disclosure is not limited to the configuration of the embodiment explained below.

### First Embodiment

### (System Outline)

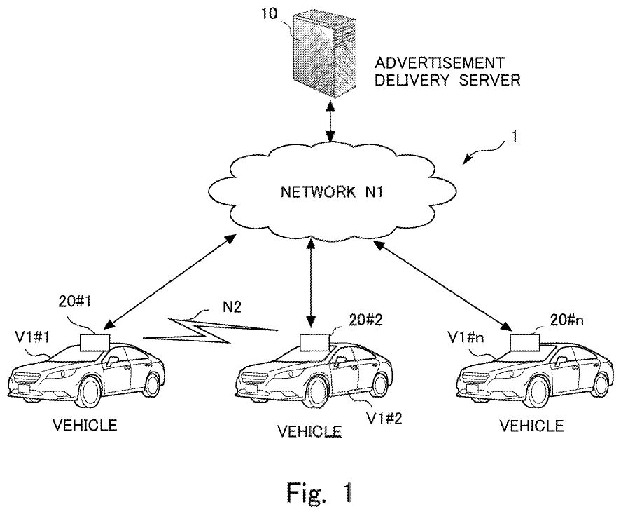

FIG. 1 illustrates exemplary system configuration of an advertisement system 1 according to a first embodiment. The advertisement system 1 illustrated in FIG. 1 is such a system that the advertisement information is displayed while enhancing or raising the advertisement effect of the store or the like which newly opened, on the vehicle which can display the advertisement information with respect to the outside of the vehicle. The advertisement information includes the advertisement content including, for example, the still image, the moving image (screen image), and the message information provided by the advertiser (for example, an enterprise or an agency that provides the merchandise and/or the service), and the privilege information (for example, coupon, point, and discount).

The advertisement system 1 according to the first embodiment is configured to include an advertisement delivery server 10 and vehicle onboard apparatuses (20#1 to 20#n) carried on a plurality of vehicles respectively which are connected to one another by means of a network N1. The advertisement delivery server 10 is an example of the “information processing apparatus”. The network N1 is, for example, a public network including, for example, the internet. However, the network N1 may include the wireless communication such as WiFi (registered trademark) or the like, the wireless network of the mobile phone network such as LTE, LTE-Advanced, 3G or the like, the exclusive network such as VPN (Virtual Private Network), and the network such as LAN (Local Area Network) or the like.

Further, the vehicle onboard apparatuses (20#1 to 20#n) can be directly communicated with each other via a network N2. The network N2 is, for example, a wireless communication network of the 5th generation mobile communication system (5G) which makes it possible to perform the inter-vehicle communication and the road-vehicle communication. However, the network N2 may include, for example, UWB (Ultra-Wideband), WiFi, and BLE (Bluetooth (registered trademark) Low Energy). The network N2 may be included in the network N1. In the following description, an explanation will be made assuming that the vehicle onboard apparatuses (20#1 to 20#n), which are carried on the respective vehicles, mutually perform the inter-vehicle communication via the network N2.

FIG. 1 representatively exemplifies one advertisement delivery server 10 and the vehicle onboard apparatuses (20#1 to 20#n) which are carried on the plurality of vehicles (V1#1 to V1#n) respectively. A plurality of advertisement delivery servers 10 may be connected to the network N1 of the advertisement system 1 according to the first embodiment. In the following description, the plurality of vehicles (V1#1 to V1#n) are collectively referred to and simply referred to as “vehicle V1” as well. The plurality of vehicle onboard apparatuses (20#1 to 20#n) are collectively referred to and referred to as “apparatus 20” as well. Further, the advertisement delivery server 10 is simply referred to as “server 10” as well.

The vehicle V1 is a vehicle which is provided with any display apparatus for displaying the advertisement information with respect to the outside of the vehicle. For example, a plurality of display apparatuses are provided, for example, on an outer wall of the body of the vehicle so that the displayed advertisement information can be visually recognized from the outer side of the vehicle by viewers existing around the vehicle V1. That is, the plurality of display apparatuses display the advertisement information toward outside of the vehicle. The display apparatus is constructed by using, for example, a liquid crystal display such as LCD (Liquid Crystal Display) or the like, an organic EL (Electro-Luminescence) display, an LED matrix (Light Emitting Diode), or a projector.

The apparatus 20 of the vehicle V1 receives, for example, the advertisement information including the data (advertisement data) of the advertisement content delivered from the server 10. Then, the vehicle V1 displays the advertisement content including, for example, the still image, the slide show, the moving image (screen image), and the message information based on the advertisement data with respect to the outside by the aid of the plurality of display apparatuses provided for the subject vehicle.

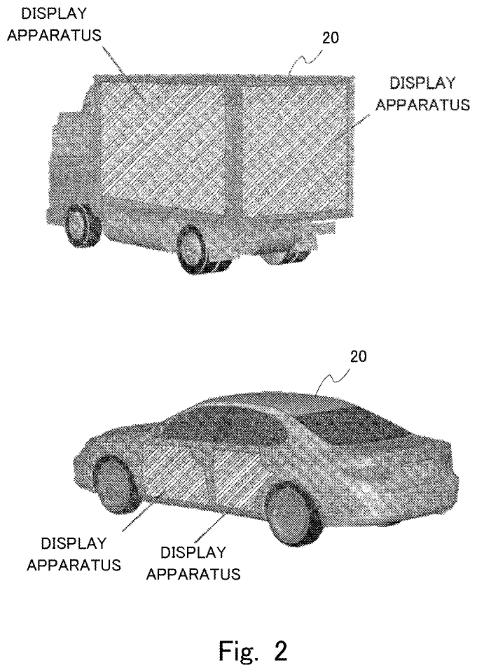

FIG. 2 explains positions of the display apparatuses provided on the vehicles V1. FIG. 2 exemplifies the plurality of display apparatuses arranged on the outer wall of the body for constructing the vehicle V1. The display apparatuses are arranged at the plurality of positions including, for example, the left side surface, the right side surface, the back portion of the vehicle, and the upper portion of the vehicle. Note that the number of the display apparatuses provided for the vehicle V1 differs depending on the type and the car model of the vehicle. For example, if the vehicle V1 is a truck, the display apparatuses can be arranged at four positions of the left side surface, the right side surface, the back portion of the vehicle, and the upper portion of the vehicle. On the other hand, if the vehicle V1 is a sedan, the display apparatuses can be arranged at five positions of the left side surface (front door), the left side surface (back door), the right side surface (front door), the right side surface (back door), and the upper portion of the vehicle. However, any position other than the above may be available as the arrangement position of the display apparatus. For example, if a projector or the like is provided, a window glass of the vehicle (for example, side window and rear window), on which the screen image can be projected, can be exemplified as the arrangement position.

The apparatus 20 is a vehicle onboard apparatus carried on the vehicle V1. Identification information (apparatus ID), which is usable to unambiguously identify the apparatus, is previously given to the apparatus 20. The apparatus ID is managed while being correlated, for example, with identification information (for example, automobile registration number (number marked on number plate or license plate)) for unambiguously identify the vehicle V1 which carries the apparatus 20. The apparatus 20 transmits the state information for indicating the state relevant to the traveling of the subject vehicle, to the server 10 periodically or in response to the request from the server 10. For example, the position information (latitude, longitude) of the vehicle V1, the speed information, and the information to indicate the traveling direction are exemplified as the state information. The apparatus 20 transmits the state information of the subject vehicle to the server 10 together with the apparatus ID. Note that the state information may include the identification information (for example, link number) of the road on which the vehicle is scheduled to travel and the identification information (for example, node number) of the intersection or the like, as being set, for example, by means of the input operation performed by the passenger who gets on the subject vehicle.

Further, the apparatus 20 directly performs the inter-vehicle communication via the network N2 with respect to the vehicle V1 which chases while following the subject vehicle. In the following description, the preceding vehicle V1 is referred to as “preceding vehicle #1” as well, and the vehicle V1, which chases the preceding vehicle #1, is referred to as “chasing vehicle #2” as well. Further, an explanation will be made assuming that the apparatus 20, which is carried on the preceding vehicle #1, is referred to as “apparatus #1”, and the apparatus 20, which is carried on the chasing vehicle #2, is referred to as “apparatus #2”.

The apparatus #1 of the preceding vehicle #1 according to this embodiment acquires the history information relevant to the traveling of the chasing vehicle #2 by means of the inter-vehicle communication. For example, the destination history and the traveling track are exemplified as the history information relevant to the traveling. The destination history is, for example, the history information of the destination set and inputted when the navigation function is utilized. Further, the traveling track is the history information in which most recent traveling points are recorded on a route at certain intervals (for example, intervals of 5 km) within a predetermined distance (for example, 1000 km). The apparatus #1 transmits, to the server 10, for example, the acquired history information relevant to the traveling, the apparatus ID of the apparatus #2 carried on the chasing vehicle #2, and the time information while correlating them with each other. Then, the apparatus #1 allows the display apparatus provided at the back portion of the vehicle to display the advertisement information of the store or the like selected on the basis of the history information which is relevant to the traveling of the chasing vehicle #2 and which is delivered from the server 10.

The server 10 according to this embodiment is the computer which manages the advertisement information delivered to the vehicle V1. The advertisement information and the information relevant to the vehicle V1 which carries the apparatus 20 are retained in the database. The information relevant to the vehicle V1 which carries the apparatus 20 includes the attribute information relevant to the attribute of the user of the vehicle V1 (for example, age, distinction of sex, occupation, taste, and hobby). Further, the advertisement information is managed, while the identification information (advertisement ID) for unambiguously identifying the information is given thereto.

The server 10 accepts the data relevant to the advertisement information by the aid of a server apparatus which is managed, for example, by an enterprise, a store, or a facility as the advertiser, and the server 10 registers the data in the database. The advertiser includes, for example, a public institution in the region and an advertising agency for mediating the delivery of the advertisement. The advertisement information registered in the database includes the location information which indicates the location of the store or the like and the store opening information which indicates the timing at which the provision of the merchandise, the service or the like was started by the store or the like.

The server 10 according to this embodiment extracts the advertisement information of the store or the like which started the provision of the merchandise, the service or the like within a predetermined period, from the advertisement information registered in the database, on the basis of the store opening information, and manages the advertisement information. Note that the predetermined period, which is provided to extract the advertisement information, is previously set, for example, by the administrator (manager or operator) of the advertisement system 1. The predetermined period is exemplified by a period on a monthly basis, for example, 1 month or 3 months.

Further, the server 10 acquires the history information relevant to the traveling of the chasing vehicle #2 and the state information of the preceding vehicle #1 (for example, the position information, the speed information, and the traveling direction) as transmitted from the preceding vehicle #1. Then, the server 10 according to this embodiment selects the advertisement information to be preferentially displayed on the preceding vehicle #1 on the basis of the position information of the preceding vehicle #1, the history information relevant to the traveling of the chasing vehicle #2, the location information for indicating the location of the store or the like, and the store opening information.

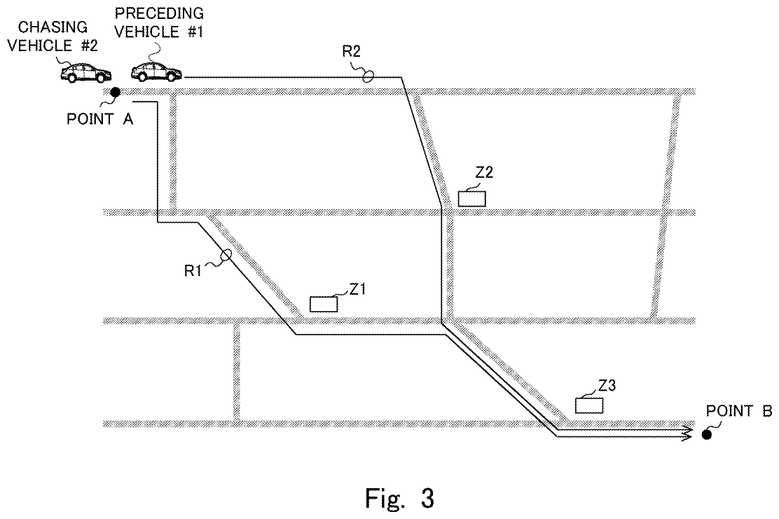

FIG. 3 explains the selection of the advertisement information. In FIG. 3, the preceding vehicle #1 and the chasing vehicle #2 are the vehicles each of which is provided with the display apparatus capable of displaying the advertisement information with respect to the outside of the vehicle. The apparatus #1 is carried on the preceding vehicle #1, and the apparatus #2 is carried on the chasing vehicle #2. Further, the stores Z1, Z2, Z3 are the stores or the like each of which started the provision of, for example, the merchandise and/or the service within the predetermined period. It is assumed that the preceding vehicle #1 and the chasing vehicle #2 travel along the route R1 or the route R2 indicated by the solid line arrows, and the preceding vehicle #1 and the chasing vehicle #2 move from the point A to the point B.

When the vehicles travel along the route R1, the preceding vehicle #1 and the chasing vehicle #2 travel in the vicinity of the locations of the store Z1 and the store Z3. The server 10 selects the advertisement information of the stores Z1, Z3 positioned in the predetermined range of the route R1 on the basis of the position information transmitted from the preceding vehicle #1. In this case, as for the predetermined range, for example, the area, which is disposed within a predetermined range (for example, radius of 10 km) about the center of the present position of the traveling of the preceding vehicle #1, is exemplified. However, the predetermined range may be a range which is designated by the district name (town, ward, city block) of the location of the store or the like which provides the merchandise and/or the service, or the predetermined range may be a range which is designated, for example, by the standard region mesh code or the divided region mesh code of the region including the location. When the preceding vehicle #1 and the chasing vehicle #2 travel in the concerning range, the advertisement information of the store or the like corresponding to the concerning range is selected.

The server 10 gives the identification information (identifier) to the selected advertisement information for preferentially displaying the information, and the information is delivered to the preceding vehicle #1. The preceding vehicle #1 allows, for example, the display apparatus provided at the back portion or the vehicle to display the delivered advertisement information while giving the preference or priority thereto. The advertisement information, which relates to the new stores Z1, Z3 that started the provision of, for example, the merchandise and/or the service in the predetermined period, is presented to the chasing vehicle #2 while giving the preference thereto as compared with the advertisement information of the other store or the like. In the following description, the identification information for performing the preferential display is referred to as “preference information” as well.

Further, the preceding vehicle #1 acquires the history information relevant to the traveling from the chasing vehicle #2, and the history information is transmitted to the server 10. The server 10 selects the advertisement information of the store or the like having no traveling history record included in the history information, on the basis of the history information of the chasing vehicle #2. For example, with reference to FIG. 3, it is assumed that the store Z1 is not included in the history information of the chasing vehicle #2. The server 10 selects the advertisement information of the store Z1 having no record in the history information relevant to the traveling of the chasing vehicle #2, from the stores each of which started the provision of, for example, the merchandise and/or the service in the predetermined period. Then, the server 10 gives the identifier to the advertisement information of the store Z1 positioned in the predetermined range of the route R1 for preferentially displaying the advertisement information, on the basis of the position information transmitted from the preceding vehicle #1, and the information is delivered to the preceding vehicle #1. The advertisement information relevant to the new store Z1 which has not been visited by the user of the chasing vehicle #2 yet is presented to the chasing vehicle #2, while giving the preference thereto as compared with the advertisement information of the other store or the like.

The same or equivalent procedure is also adopted when the vehicles travel along the route R2. As illustrated in FIG. 3, when the vehicles travel along the route R2, the preceding vehicle #1 and the chasing vehicle #2 travel in the vicinity of the locations of the store Z2 and the store Z3. The server 10 selects the advertisement information of the stores Z2, Z3 positioned in the predetermined range of the route R2 in the same manner as described above. The server 10 gives the identification information (identifier) to the advertisement information for preferentially displaying the advertisement information, and the information is delivered to the preceding vehicle #1. The advertisement information, which relates to the new stores Z2, Z3 that started the provision of, for example, the merchandise and/or the service in the predetermined period, is presented to the chasing vehicle #2 while giving the preference thereto as compared with the advertisement information of the other store or the like.

Further, the server 10 selects the advertisement information of the store or the like having no traveling history record included in the history information, on the basis of the history information of the chasing vehicle #2. For example, with reference to FIG. 3, it is assumed that the store Z2 is not included in the history information of the chasing vehicle #2. The server 10 selects the advertisement information of the store Z2 having no record in the history information relevant to the traveling of the chasing vehicle #2, from the stores each of which started the provision of, for example, the merchandise and/or the service in the predetermined period. Then, the server 10 gives the identifier to the advertisement information of the store Z2 positioned in the predetermined range of the route R2 for preferentially displaying the advertisement information, as selected on the basis of the position information transmitted from the preceding vehicle #1, and the information is delivered to the preceding vehicle #1. The advertisement information relevant to the new store Z2 which has not been visited by the user of the chasing vehicle #2 yet is presented to the chasing vehicle #2, while giving the preference thereto as compared with the advertisement information of the other store or the like.

Note that the preceding vehicle #1 may display the advertisement information selected on the basis of the history information of the chasing vehicle #2, on the back portion of the vehicle, on condition that the speed of the subject vehicle is lower than a previously set threshold value (for example, 20 km/h). When the speed is reduced, for example, on account of the waiting for a traffic light or the turning to the right or left, it is possible to present the advertisement information relevant to the new store Z2 which is desired by the user of the chasing vehicle #2 and which has not been visited by the user of the chasing vehicle #2 yet, while considering the safety in relation to the traveling.

### (Hardware Configuration)

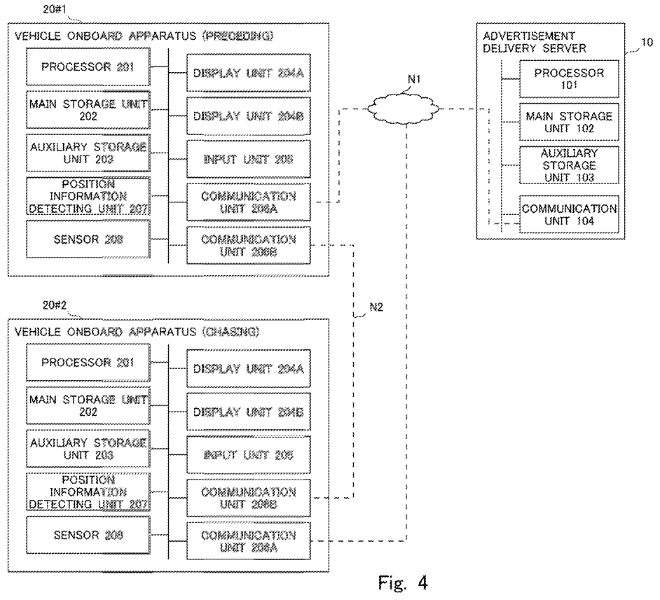

FIG. 4 illustrates an example of respective hardware configuration of the server 10, the apparatus #1 carried on the preceding vehicle #1, and the apparatus #2 carried on the chasing vehicle #2. Note that the apparatus #1 and the apparatus #2 are configured similarly or equivalently. In the following description, the apparatus #1 and the apparatus #2 will be explained as “apparatus 20”.

With reference to FIG. 4, the server 10 is, for example, a general purpose or exclusive computer. The server 10 includes constitutive components of a processor 101, a main storage unit 102, an auxiliary storage unit 103, and a communication unit 104 which are connected to one another by means of a bus. The main storage unit 102 and the auxiliary storage unit 103 are recording media capable of being read by the server 10. A plurality of constitutive components may be provided for each of the constitutive components as described above. Alternatively, it is also allowable that a part or parts of the constitutive component or components is/are not provided. The processor 101 of the server 10 is an example of the “controller”.

The processor 101 is, for example, CPU (Central Processing Unit). The processor 101 executes the computer program executably developed in the working area of the main storage unit 102, and the processor 101 controls the entire server 10. The processor 101 provides the function which conforms to a predetermined purpose by controlling the peripheral devices in accordance with the execution of the computer program. The processor 101 is not limited to a single processor. The processor 101 may be configured as a multiprocessor. Alternatively, single CPU, which is connected by a single socket, may be configured as a multicore. Note that a part or parts of the processing function provided by the server 10 may be provided, for example, by DSP (Digital Signal Processor), ASIC (Application Specific Integrated Circuit), or GPU (Graphics Processing Unit). Further, at least a part or parts of the processing function may be exclusive LSI (large scale integration) including, for example, FPGA (Field-Programmable Gate Array), numerical data processor, and image processing processor, or any other digital circuit or analog circuit.

The main storage unit 102 stores, for example, the computer program executed by the processor 101 and the data processed by the processor 101. The main storage unit 102 is, for example, a flash memory, RAM (Random Access Memory), or ROM (Read Only Memory). The auxiliary storage unit 103 is a nonvolatile storage device which readably/writably stores, on the recording medium, various programs including OS (Operating System) and various data. The auxiliary storage unit 103 is, for example, a flash memory, a hard disk drive (HDD, Hard Disk Drive), or SSD (Solid State Drive). Note that OS includes a communication interface program for accepting/delivering the data with respect to an external device or the like connected via the communication unit 104. The communication unit 104 is an interface with respect to the network N1. The communication unit 104 includes, for example, a LAN (Local Area Network) interface board and a wireless communication circuit for the wireless communication. The server 10 is connected to the network N1 via the communication unit 104 for making communication, for example, with the apparatuses #1, #2 via the network N1.

Note that the hardware configuration of the server 10 is not limited to the configuration illustrated in FIG. 4. The server 10 can read, for example, the program recorded on the transportable recording medium, the server 10 can develop the program in the main storage unit 102, and the server 10 can execute the program. The transportable recording medium is, for example, a disk recording medium such as USB (Universal Serial Bus) memory, CD (Compact Disc), DVD (Digital Versatile Disc), or Blu-ray (registered trademark) disk.

The apparatus 20 has a processor 201, a main storage unit 202, an auxiliary storage unit 203, a display unit 204A, a display unit 204B, an input unit 205, a communication unit 206A, a communication unit 206B, a position information detecting unit 207, and a sensor 208. The processor 201, the main storage unit 202, the auxiliary storage unit 203, and the communication unit 206A are the same as or equivalent to the processor 101, the main storage unit 102, the auxiliary storage unit 103, and the communication unit 104 of the server 10, and hence any explanation thereof will be omitted. A plurality of constitutive components may be provided for each of the constitutive components described above. Alternatively, it is also allowable that a part or parts of the constitutive components is/are not provided.

The display unit 204A is, for example, a display device such as LCD or EL (Electroluminescence) panel. The display unit 204A may be provided with a speaker or the like for announcing the voice guidance, the message and the like in the vehicle. The display unit 204B is a unit composed of a plurality of display apparatuses for displaying the advertisement information with respect to the outside of the vehicle. The display unit 204B is constructed, for example, by a liquid crystal display such as LCD or the like, an organic EL display, an LED matrix, and/or a projector. In this embodiment, the display unit 204B includes at least the display apparatus provided at the back portion of the vehicle. The advertisement information is provided for the chasing vehicle #2 by the aid of the display apparatus.

The input unit 205 includes, for example, a touch panel or a push-button which is capable of inputting symbols such as letters or characters or the like, a microphone which is capable of inputting the voice, and a camera which is capable of photographing a moving image or a still image. The communication unit 206B is, for example, a communication circuit which is adapted to the wireless communication such as the 5th generation mobile communication system (5G), UWB, WiFi, BLE or the like. The apparatus #1 carried on the preceding vehicle #1 and the apparatus #2 carried on the chasing vehicle #2 perform the inter-vehicle communication by the aid of the respective communication units 206B. The apparatus #1 of the preceding vehicle #1 acquires the history information in relation to the traveling of the chasing vehicle #2 by the aid of the communication unit 206B.

The position information detecting unit 207 is the means for detecting the position information of the vehicle V1 on which the apparatus 20 is carried. The position information detecting unit 207 detects the position information of the subject vehicle (latitude, longitude), for example, on the basis of the GPS signals from a plurality of GPS (Global Positioning Satellite) satellites which orbit around the earth. The apparatus 20 performs the route guidance (navigation function) until arrival at the destination inputted by the operation by the aid of the input unit 205 on the basis of the position information detected by the aid of the position information detecting unit 207. The route until arrival at the destination is set by making reference to the map data stored in the auxiliary storage unit 203. The apparatus 20 provides the route guidance until arrival at the destination, for example, such that the detected position of the subject vehicle and the route until arrival at the destination are displayed in a superimposed manner on the map displayed by the aid of the display unit 204A, and the traveling direction for the turning to the right or left or the like is guided by the aid of the voice or the like at the intersection or the like. Note that the destination information relevant to the destination inputted by the operation and the route information relevant to the route until arrival at the destination set by making reference to the map data are retained in a predetermined area of the main storage unit 202. Further, the history information of the destination subjected to the route guidance and the history information relevant to the traveling such as the traveling track or the like are recorded in a predetermined area of the auxiliary storage unit 203.

The sensor 208 is an assembly of sensors carried on the vehicle V1. The sensor 208 includes one or more sensors for detecting the information relevant to the traveling state and the situation around the vehicle, including, for example, a vehicle speed sensor, an acceleration sensor, a radar, a camera, and an azimuth angle sensor. Further, the information, which is detected by the sensor 208, includes the status information of, for example, operation switches and operation buttons provided for the vehicle V1. However, the information, which is detected by the sensor 208, may include, for example, the data relevant to, for example, the degree of congestion in the vicinity of the vehicle, the speeds of surrounding vehicles, and the control of traffic signals, as acquired by the aid of the road-vehicle communication and/or the inter-vehicle communication.

### (Functional Configuration)

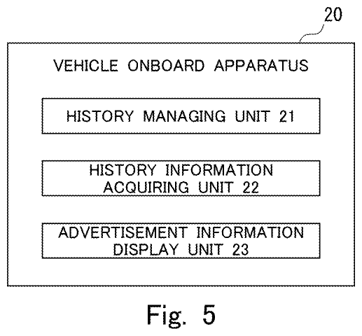

FIG. 5 illustrates exemplary functional configuration of the apparatus 20. The apparatus 20 includes, as functional constitutive components, a history managing unit 21, a history information acquiring unit 22, and an advertisement information display unit 23. As for the functional constitutive components as described above, the functional constitutive components are provided, for example, such that the various programs, which are stored in the auxiliary storage unit 203, are developed and executed in the main storage unit 202 by means of the processor 201 of the apparatus 20. However, any one of the respective functional constitutive components or any part of the processing thereof may be executed by any hardware circuit.

The history managing unit 21 acquires the history information (for example, destination history, traveling track) relevant to the traveling history of the subject vehicle recorded, for example, in the auxiliary storage unit 203, in response to the request from the preceding vehicle #1. Then, the history managing unit 21 transmits the history information relevant to the traveling of the subject vehicle (chasing vehicle #2) together with the apparatus ID of the subject apparatus (apparatus #2) by means of the inter-vehicle communication, for example, by using the destination or address of the apparatus ID of the apparatus #1 carried on the preceding vehicle #1.

The history information acquiring unit 22 acquires the history information relevant to the traveling of the chasing vehicle #2 (hereinafter referred to as “traveling history information” as well) from which the response was made by the aid of the communication unit 206B. Further, the history information acquiring unit 22 acquires the position information (latitude, longitude) of the subject vehicle (preceding vehicle #1) detected by the aid of the position information detecting unit 207. Then, the history information acquiring unit 22 transmits the traveling history information of the chasing vehicle #2, the apparatus ID of the apparatus #2, and the position information of the subject vehicle (preceding vehicle #1) to the server 10. The information is transmitted to the server 10 via the communication unit 206A together with the apparatus ID of the apparatus #1 carried on the preceding vehicle #1.

The advertisement information display unit 23 acquires the advertisement information delivered from the server 10, and the information is stored in a predetermined area of the auxiliary storage unit 203. The preference information, which is available when the display is performed, is added to the advertisement information delivered from the server 10 as described later on. The advertisement information display unit 23 displays the advertisement information in accordance with the preference designation given to the advertisement information. The advertisement information is displayed on at least the display apparatus (display unit 204B) arranged at the back portion of the vehicle. Note that the advertisement information display unit 23 may display the advertisement information, for example, on condition that the speed of the subject vehicle is lower than a previously set threshold value (for example, 20 km/h).

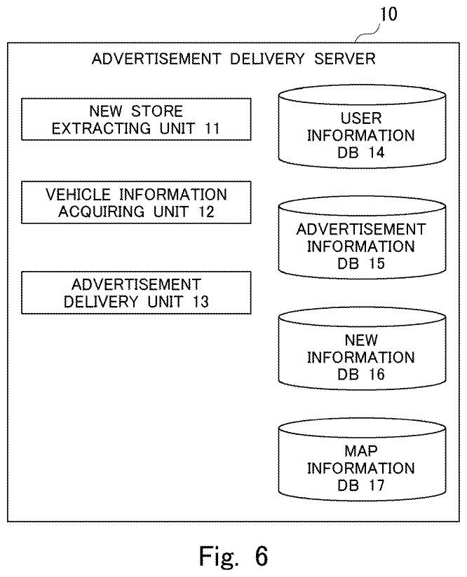

FIG. 6 illustrates exemplary functional configuration of the server 10. The server 10 includes, as functional constitutive components, a new store extracting unit 11, a vehicle information acquiring unit 12, an advertisement delivery unit 13, a user information database (DB) 14, an advertisement information DB 15, a new information DB 16, and a map information DB 17. As for the functional constitutive components as described above, the functional constitutive components are provided, for example, such that the various programs, which are stored in the auxiliary storage unit 103, are developed and executed in the main storage unit 102 by means of the processor 101 of the server 10. However, any one of the respective functional constitutive components or any part of the processing thereof may be executed by any hardware circuit. Further, any one of the respective functional constitutive components or any part of the processing thereof may be executed by any other computer connected to the network N1.

The new store extracting unit 11 extracts the advertisement information of the store or the like which newly opened in a predetermined period, from the advertisement information managed by the advertisement information DB 15, and the information is stored in the new information DB 16. The store or the like, which newly opened, is extracted, for example, on the basis of the store opening information for indicating the timing at which the provision of the merchandise and/or the service was started. The server 10 accepts the data relevant to the advertisement information by the aid of a server apparatus operated or managed, for example, by an enterprise, a store, or a facility as the advertiser, and the data is registered in the advertisement information DB 15. Note that the advertiser includes, for example, a public institution in the region and an advertising agency for mediating the delivery of the advertisement. The new store extracting unit 11 makes reference to the advertisement information DB 15 to extract the advertisement information of the store or the like which newly opened, to be stored in the new information DB 16, on the basis of the store opening information included in the advertisement information. The extraction of the advertisement information is executed periodically.

The vehicle information acquiring unit 12 acquires the information relevant to the chasing vehicle #2 transmitted from the preceding vehicle #1. The information relevant to the chasing vehicle #2 includes the apparatus ID of the apparatus #2 carried on the chasing vehicle #2 and the traveling history information (for example, destination history, traveling track). Further, the vehicle information acquiring unit 12 acquires, for example, the position information (latitude, longitude) transmitted from the preceding vehicle #1 together with the apparatus ID of the apparatus #1. The vehicle information acquiring unit 12 temporarily stores the information relevant to the chasing vehicle #2 in a predetermined area of the main storage unit 102. Similarly, the position information of the preceding vehicle #1 and the apparatus ID of the apparatus #1 are stored in the main storage unit 102 together with the time information. The vehicle information acquiring unit 12 delivers the information relevant to the chasing vehicle #2, the position information of the preceding vehicle #1, and the apparatus ID of the apparatus #1 to the advertisement delivery unit 13.

The advertisement delivery unit 13 selects the advertisement information to be displayed on the back portion of the vehicle of the preceding vehicle #1 on the basis of the information relevant to the chasing vehicle #2 delivered from the vehicle information acquiring unit 12 and the position information of the preceding vehicle #1. The advertisement delivery unit 13 makes reference, for example, to the new information DB 16 to select the advertisement information of the store or the like which newly opened and which is positioned in the predetermined range, on the basis of the position information of the preceding vehicle #1.

Further, the advertisement delivery unit 13 specifies the attribute information relevant to the attribute of the user of the chasing vehicle #2 (for example, age, distinction of sex, occupation, taste, and hobby) on the basis of the apparatus ID of the apparatus #2. The attribute information is specified by making reference to the user information DB 14. Then, the advertisement delivery unit 13 makes reference to the advertisement information DB 15 to select the advertisement information corresponding to the attribute information of the user of the chasing vehicle #2.

The preference information (for example, an identifier for indicating the preference designation), which is available to preferentially display the information as compared with any other advertisement information, is given by the advertisement delivery unit 13 to the advertisement information of the store or the like which newly opened. The information is delivered to the preceding vehicle #1. Further, the advertisement information, which is selected on the basis of, for example, the hobby and/or the taste of the user of the chasing vehicle #2, is delivered by the advertisement delivery unit 13 to the preceding vehicle #1.

The advertisement information of the store or the like which newly opened and to which the preference information is given and the advertisement information which is selected on the basis of, for example, the hobby and/or the taste of the user of the chasing vehicle #2 are stored by the preceding vehicle #1 in a predetermined area of the auxiliary storage unit 203. Then, the preceding vehicle #1 displays the advertisement information on the display apparatus (display unit 204B) provided at the back portion of the vehicle, in accordance with the preference information given to the advertisement information. That is, the advertisement information of the store or the like which newly opened and which is located in the traveling area is provided to the user of the chasing vehicle #2, while giving the preference or priority thereto as compared with the advertisement information selected on the basis of, for example, the hobby and/or the taste of the user.

Note that the advertisement delivery unit 13 reflects the traveling history information of the chasing vehicle #2 when the advertisement information of the store or the like which newly opened is selected. That is, the advertisement delivery unit 13 selects the advertisement information of the store or the like which has no record in the traveling history information of the chasing vehicle #2. The advertisement information, which is relevant to the store or the like that has not been visited by the user of the chasing vehicle #2 yet, is selected from the stores or the like which newly opened. Then, the advertisement delivery unit 13 gives the preference information to the selected advertisement information, and the information is delivered to the preceding vehicle #1. The advertisement information, which is relevant to the store or the like that has not been visited by the user of the chasing vehicle #2 yet, is delivered to the preceding vehicle #1 together with the advertisement information which is selected on the basis of, for example, the hobby and/or the taste of the user.

The preceding vehicle #1 displays the advertisement information delivered from the server 10 on the display apparatus (display unit 204B) provided at the back portion of the vehicle, in accordance with the preference information given to the advertisement information. As a result, the advertisement information, which is relevant to the store or the like that has not been visited by the user of the chasing vehicle #2 yet and which is included in the stores or the like that newly opened, is provided while giving the preference thereto as compared with the advertisement information selected, for example, on the basis of the hobby and/or taste of the user.

The user information DB 14 manages the information relevant to the user of the vehicle V1 which carries the apparatus 20. The information relevant to the user is registered, for example, by the aid of an information processing terminal possessed by the user, including, for example, a smartphone, a tablet terminal, a personal information terminal, and PC (Personal Computer).

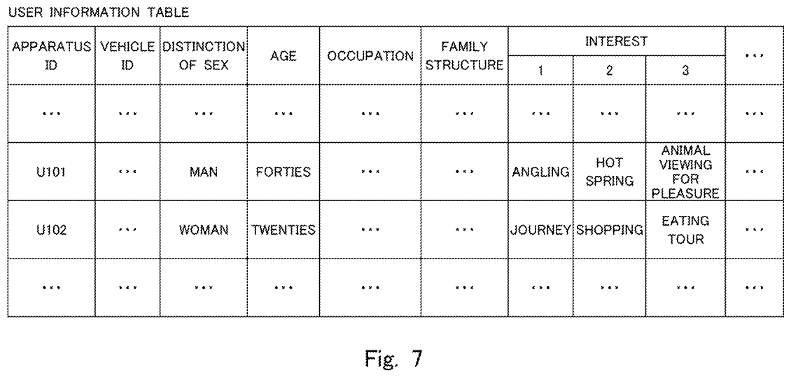

FIG. 7 illustrates exemplary user information stored in the user information DB 14. As exemplified in FIG. 7, the user information is managed as a user information table. As for the information registered in the user information table, it is possible to appropriately add, change, and/or delete the field.

The user information table exemplified in FIG. 7 is constructed to include respective fields of “apparatus ID”, “vehicle ID”, “distinction of sex”, “age”, “occupation”, “family structure”, and “interest”. The identification information (apparatus ID) for unambiguously identify or distinguish the apparatus 20 carried on the vehicle V1 is stored in the apparatus ID. The apparatus ID may include the IP address and/or the MAC address (Media Access Control address) of the apparatus 20. The identification information (vehicle ID) for unambiguously identifying the vehicle V1 is stored in the vehicle ID. The vehicle ID is, for example, the automobile registration number (number marked on number plate or license plate).

The information for indicating the distinction of sex of the user (for example, man, woman) is stored in the distinction of sex. The information for indicating the age (generation) of the user is stored in the age. The information for indicating the occupation of the user is stored in the occupation. The occupation may include the information for indicating the type of industry or business and/or the type of occupation. The information (for example, number of members) for indicating the family structure of the user is stored in the family structure.

The information for indicating the hobby and/or the interested matter of concern of the user is stored in the interest. A plurality of pieces of information to be stored in the field can be registered. In the example illustrated in FIG. 7, the three pieces of information of interest are exemplified. For example, in the case of the user ID “U101” who is a man of the age of “forties”, “angling”, “hot spring”, and “animal viewing for pleasure” are stored. In the case of the user ID “U102” who is a woman of the age of “twenties”, “journey”, “shopping”, and “eating tour” are stored.

The advertisement delivery unit 13 specifies the record registered in the user information DB 14 on the basis of the apparatus ID of the apparatus #2 carried on the chasing vehicle #2. Then, the advertisement delivery unit 13 selects the advertisement information to be delivered to the chasing vehicle #1 on the basis of the attribute information of the user (for example, distinction of sex, age, occupation, family structure, and interest) stored in the record.

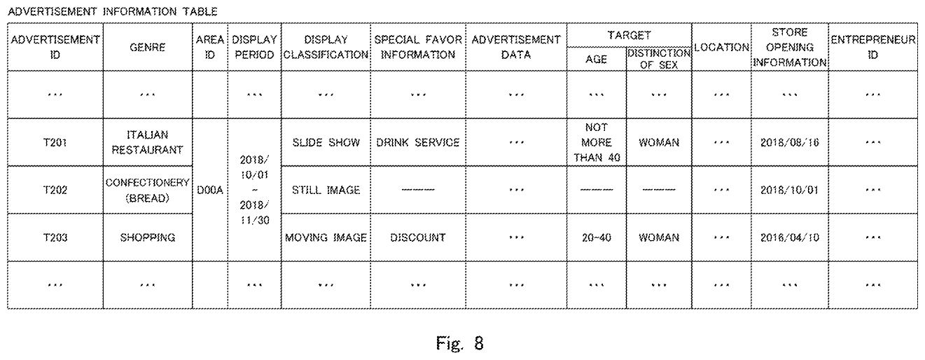

With reference to FIG. 6 again, the advertisement information DB 15 manages the advertisement information to be delivered to the vehicle V1. FIG. 8 illustrates exemplary advertisement information stored in the advertisement information DB 15. As exemplified in FIG. 8, the advertisement information is managed as an advertisement information table. As for the information registered in the advertisement information table, it is possible to appropriately add, change, and/or delete the field.

The advertisement information table exemplified in FIG. 8 has respective fields of “advertisement ID”, “genre”, “area ID”, “display period”, “display classification”, “special favor information”, “advertisement data”, “target”, “location”, “store opening information”, and “entrepreneur ID”. The identification information (advertisement ID) for identifying the advertisement content accepted from the advertiser is stored in the advertisement ID. The advertisement ID is given when the advertisement content is registered. The information for indicating the division to which the merchandise or the service advertised by the advertisement information belongs is stored in the genre. The information (area ID) for indicating the region in which the store, the facility or the like for providing the merchandise or the service is positioned is stored in the area ID. The area ID is, for example, the region mesh information (for example, standard region mesh code, or divided region mesh code) of the region in which the store, the facility or the like is positioned.

The information for indicating the period in which the advertisement information is to be delivered is stored in the display period. The display period may include the time zone for displaying the advertisement information. The information for displaying the display form of the advertisement content is stored in the display classification. For example, the still image, the slide show, and the moving image are exemplified as the display form of the advertisement content. The content of the special favor (for example, coupon and/or discount of usage charge) provided to the user by the advertiser is stored in the special favor information. Note that if the special favor information is absent, the information for indicating the absence of the special favor information (for example, “ - - - ” or blank) is stored. The data of the advertisement content is stored in the advertisement data. However, the information stored in the advertisement data may be the identification number for indicating the advertisement data stored, for example, in any other table.

The information for designating the user as the advertisement target of the advertisement content is stored in the target. A plurality of pieces of information can be registered as the information stored in the field. In the example illustrated in FIG. 8, the pieces of information for designating the age and the distinction of sex are exemplified. For example, in the case of the advertisement ID “T201”, the distinction of sex of “woman” having the age of “not more than 40” is designated as the target. In the case of the advertisement ID “T203”, the distinction of sex of “woman” having the age of “20-40” is designated as the target. Note that if the designation of the user as the advertisement target is absent, the information for indicating the absence of the designation (for example, “ - - - ” or blank) is stored.

The information for indicating the location of, for example, the store or the facility which provides the merchandise or the service advertised by the advertisement information is stored in the location. The position information such as the latitude, the longitude or the like at which the store or the like is positioned is exemplified as the information for indicating the location. However, the information for indicating the location may be, for example, the address. The information for indicating the timing at which the provision of the merchandise, the service or the like was started (for example, annual (yearly) history, monthly history, daily history) is stored in the store opening information. In the example illustrated in FIG. 8, the advertisement information of the genre “Italian restaurant” opened on the date of the store opening information “2018/08/16” and the advertisement information of the genre “confectionery (bread)” opened on the date of the store opening information “2018/10/01” are exemplified. The identification information (entrepreneur ID) for identifying the provider of the advertisement information is stored in the entrepreneur ID. The entrepreneur ID is, for example, an entrepreneur code given to the provider of the advertisement information.

The new store extracting unit 11 illustrated in FIG. 6 extracts the advertisement information of the store or the like which newly opened in a predetermined period, on the basis of the store opening information for indicating the timing at which the provision of the merchandise, the service or the like was started, of the advertisement information registered in the advertisement information DB 15. The information is stored in the new information DB 16. Note that the advertisement information, which is stored in the new information DB 16, has the content which is the same as or equivalent to that illustrated in FIG. 8, and hence any explanation thereof will be omitted.

The advertisement delivery unit 13 selects the advertisement information on the basis of the genre of the advertisement information registered in the advertisement information DB 15 and the attribute information of the user (for example, distinction of sex, age, occupation, family structure, and interest) registered in the user information DB 14. For example, the advertisement ID's “T201”, “T202”, which are divided into the genres “Italian restaurant”, “confectionery (bread)” illustrated in FIG. 8, are selected as the relevant advertisement information with respect to the user ID “U102” having “eating tour” stored in the interest field illustrated in FIG. 7.

The map information, which includes the map data including the planimetric feature positions and the POI (Point of interest) information of letters or characters, photographs and the like for indicating the characteristics of the respective points on the map data, is stored in the map information DB 17. Note that the map information DB 17 may be provided by any other system connected to the network N1, for example, GIS (Geographic Information System).

### (Process Flow)

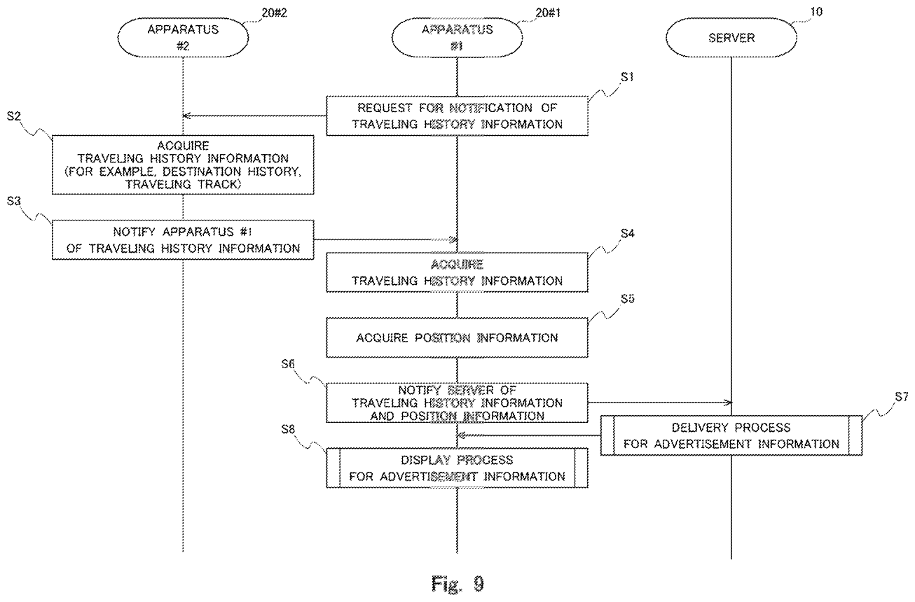

Next, an explanation will be made about the processes of the advertisement system 1 according to this embodiment with reference to FIGS. 9 to 11. The processes illustrated in FIGS. 9 to 11 are executed periodically. FIG. 9 illustrates a sequence diagram illustrating an exemplary processing procedure executed by the server 10, the apparatus #1 carried on the preceding vehicle #1, and the apparatus #2 carried on the chasing vehicle #2.

With reference to FIG. 9, the apparatus #1 carried on the preceding vehicle #1 transmits the request for notification of the traveling history information relevant to the traveling (for example, destination history and traveling track) with respect to the apparatus #2 carried on the chasing vehicle #2 (S1). The request for notification of the traveling history information is performed after establishing the link of the inter-vehicle communication between the preceding vehicle #1 and the chasing vehicle #2. The apparatus #1 transmits the request for notification of the traveling history information by using the apparatus ID of the apparatus #2 as the destination or address.

If the apparatus #2 accepts the request for notification of the traveling history information from the preceding vehicle #1 (apparatus #1), the apparatus #2 executes the response process for the traveling history information. The apparatus #2 acquires, for example, the traveling history information recorded in a predetermined area of the auxiliary storage unit 203 (S2). Then, the apparatus #2 adds the apparatus ID of the subject vehicle to the acquired traveling history information, and the apparatus #2 notifies the preceding vehicle #1 of the information (S3).

If the apparatus #1 accepts the notification of the traveling history information notified from the chasing vehicle #2 (apparatus #2), the apparatus #1 acquires the traveling history information (S4). Further, the apparatus #1 acquires the present position information of the subject vehicle detected by the aid of the position information detecting unit 207 (S5). The apparatus #1 temporarily stores the traveling history information and the position information of the subject vehicle in a predetermined area of the main storage unit 202. The apparatus #1 notifies the server 10 of the traveling history information of the chasing vehicle #2 and the position information of the subject vehicle, by the aid of the communication unit 206A. The traveling history information of the chasing vehicle #2, the apparatus ID of the apparatus #2, and the position information of the subject vehicle are transmitted to the server 10 which delivers the advertisement information via the network N1. Note that if the chasing vehicle #2 is not present, the server 10 is notified of the position information of the subject vehicle acquired in the process of S5.

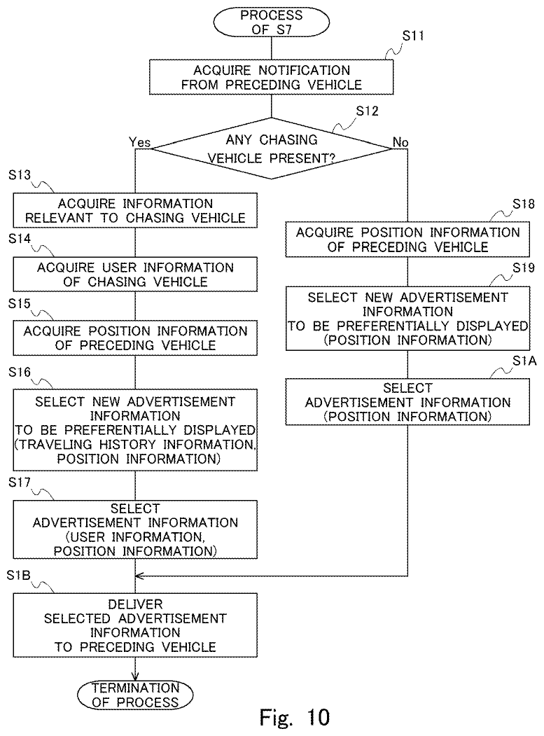

If the server 10 accepts the notification transmitted from the preceding vehicle #1 (apparatus #1) via the network N1, the server 10 executes the delivery process for the advertisement information (S7). The advertisement information, which is selected by the process of S7, is delivered to the preceding vehicle #1. Details of the process of S7 will be explained with reference to FIG. 10.

FIG. 10 illustrates a flow chart illustrating a detailed exemplary process of S7. With reference to FIG. 10, the server 10 acquires the notification transmitted from the apparatus #1 of the preceding vehicle #1 (S11). If the chasing vehicle #2 is present, the traveling history information of the chasing vehicle #2, the apparatus ID of the apparatus #2, and the position information of the preceding vehicle #1 are acquired. On the other hand, if the chasing vehicle #2 is not present, the position information of the preceding vehicle #1 is acquired.

In the process of S12, the server 10 judges whether or not the chasing vehicle #2 is present. The presence of the chasing vehicle #2 is judged, for example, depending on whether or not the apparatus ID of the apparatus #2 carried on the chasing vehicle #2 is included in the notification acquired in the process of S11.

If the apparatus ID of the apparatus #2 is included in the notification acquired in the process of S11 (S12, “Yes”), then the server 10 judges that the chasing vehicle #2 is present, and the routine proceeds to the process of S13. On the other hand, if the apparatus ID of the apparatus #2 is not included in the notification acquired in the process of S11 (S12, “No”), then the server 10 judges that the chasing vehicle #2, which can be communicated with the preceding vehicle #1 by the aid of the inter-vehicle communication, is not present, and the routine proceeds to the process of S18.

In the process of S13, the server 10 acquires the information relevant to the chasing vehicle #2. The information relevant to the chasing vehicle #2 includes the traveling history information of the chasing vehicle #2 and the apparatus ID of the apparatus #2. The server 10 acquires the user information of the chasing vehicle #2 on the basis of the apparatus ID of the apparatus #2 (S14). The server 10 makes reference, for example, to the user information DB 14 to specify the record corresponding to the apparatus ID of the apparatus #2. The server 10 delivers, to the process of S17, the record specified from the user information DB 14.

In the process of S15, the server 10 acquires the position information of the preceding vehicle #1. The position information, the apparatus ID of the apparatus #1 carried on the preceding vehicle #1, and the time information are temporarily stored by the server 10 in a predetermined area of the main storage unit 102, while being correlated with each other, and the routine proceeds to the process of S16.

In the process of S16, the new advertisement information to be preferentially displayed is selected on the basis of the traveling history information of the chasing vehicle #2 and the position information of the preceding vehicle #1. The server 10 makes reference, for example, to the new information DB 16 to specify the record of the store or the like which newly opened and which is positioned within a predetermined range with respect to the traveling position of the preceding vehicle #1. The record is specified on the basis of the information which indicates the location of the store or the like stored in the location field. The server 10 specifies, for example, the record of the store or the like which newly opened and which has the location included within the predetermined range with respect to the traveling position of the preceding vehicle #1.

Then, the server 10 further specializes the record of the store or the like which has no record in the traveling history information of the chasing vehicle #2, from the records specified from the position information of the preceding vehicle #1. For example, if the destination information recorded in the destination history indicates the location of the store or the like which newly opened and/or the parking place of the store or the like at or after the timing at which the store opened, the server 10 estimates that the user has already visited the store. Similarly, if the traveling track, which was recorded at or after the timing at which the store opened, includes the location of the store or the like which newly opened and/or the parking place of the store or the like, the server 10 estimates that the user has already visited the store. The server 10 selects the record of any store other than the store or the like which is estimated to be already visited, from the records specified from the position information of the preceding vehicle #1. Then, the server 10 acquires the advertisement information (advertisement data) stored in the selected record and gives the preference information (for example, an identifier to indicate the preferential designation) to the advertisement information for preferentially displaying the advertisement information as compared with the other advertisement information. The information is delivered to the process of S1B.

In the process of S17, the server 10 selects the advertisement information on the basis of the information (user information) relevant to the user of the chasing vehicle #2 and the position information of the preceding vehicle #1. The server 10 makes reference, for example, to the advertisement information DB 15 to specify the record of the advertisement information of the area ID corresponding to the position information acquired from the preceding vehicle #1 with the present date being within the display period. Then, the server 10 selects the advertisement information relevant to the attribute information of the user (for example, distinction of sex, age, occupation, family structure, and interest) from the specified records. For example, the record of the advertisement information divided into the genre corresponding to the interest of the user or the like is selected. Further, the record of the advertisement information, in which the distinction of sex, the age, the occupation, and the family structure of the user conform to the condition designated in the target field, is selected. The server 10 acquires the advertisement information (advertisement data) stored in the selected record, and the information is delivered to the process of S1B.

In the process of S18, the position information of the preceding vehicle #1 is acquired. The position information, the apparatus ID of the apparatus #1 carried on the preceding vehicle #1, and the time information are temporarily stored by the server 10 in a predetermined area of the main storage unit 102, while being correlated with each other, and the routine proceeds to the process of S19.

In the process of S19, the new advertisement information to be preferentially displayed is selected on the basis of the position information of the preceding vehicle #1. The server 10 makes reference, for example, to the new information DB 16 to select the record of the store or the like which newly opened and which has the location of the store or the like stored in the location field being positioned within a predetermined range with respect to the traveling position of the preceding vehicle #1. Then, the server 10 acquires the advertisement information (advertisement data) stored in the selected record and gives the preference information (for example, an identifier to indicate the preferential display) to the advertisement information for preferentially displaying the advertisement information as compared with the other advertisement information. The information is delivered to the process of S1B.

In the process of S1A, the advertisement information, which is to be displayed on the preceding vehicle #1, is selected on the basis of the position information acquired from the preceding vehicle #1. The server 10 makes reference, for example, to the advertisement information DB 15 to specify the record of the advertisement information of the area ID corresponding to the position information acquired from the preceding vehicle #1 with the present date being within the display period. Then, the server 10 acquires the advertisement information (advertisement data) stored in the selected record, and the information is delivered to the process of S1B. According to the process of S1A, the advertisement information of the area ID corresponding to the traveling position, which is directed to an unspecified large number of users as the advertisement target, is selected.

In the process of S1B, the advertisement information, which is selected in accordance with the processes of S16 to S17 and S19 to S1A, is delivered by the server 10 via the communication unit 104 to the preceding vehicle #1. The server 10 transmits the selected advertisement information to the network N1 by using the apparatus ID of the apparatus #1 as the destination or address. After the process of S1B, the process illustrated in FIG. 10 is terminated.

If the chasing vehicle #2 is present, the advertisement information of the new store or the like that opened within the predetermined period, in which the traveling history information record for the chasing vehicle is reflected, is delivered to the preceding vehicle #1 together with the preference information. Further, the advertisement information, which is relevant to the user attribute information of the chasing vehicle #2 (for example, distinction of sex, age, occupation, family structure, and interest), is delivered to the preceding vehicle #1.

If any chasing vehicle #2, which can make communication with the preceding vehicle #1, is not present, the advertisement information of the new store or the like existing within the predetermined range with respect to the traveling position of the preceding vehicle #1 is delivered to the preceding vehicle #1 together with the preference information. Further, the advertisement information of the area ID including the traveling position of the preceding vehicle #1 in the area with the present date being within the display period is delivered to the preceding vehicle #1.

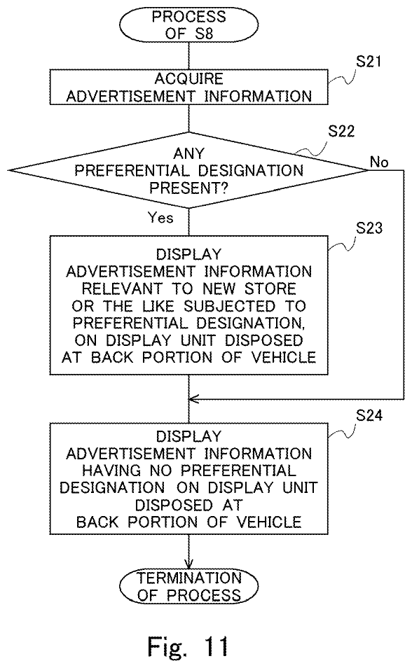

With reference to FIG. 9 again, if the apparatus #1, which is carried on the preceding vehicle #1, accepts the advertisement information delivered from the server 10 to the subject vehicle via the communication unit 206A, the apparatus #1 executes the display process for displaying the advertisement information (S8). In accordance with the process of S8, the advertisement information, which relates to the new store that started the provision of the merchandise, the service or the like in the predetermined period, is displayed on the display apparatus (display unit 204B) provided at the back portion of the vehicle of the preceding vehicle #1 while giving the preference thereto as compared with the other advertisement information. Details of the process of S8 will be explained by using FIG. 11.

FIG. 11 illustrates a flow chart illustrating a detailed exemplary process of S8. With reference to FIG. 11, the apparatus #1 acquires the advertisement information delivered from the server 10 (S21). The apparatus #1 temporarily stores the acquired advertisement information in a predetermined area of the main storage unit 202, and the routine proceeds to the process of S22.

In the process of S22, the apparatus #1 judges whether or not the advertisement information, to which the preference information (designation of preferential display) is given, is present. If the advertisement information, to which the preferential information is given, is present (S22, “Yes”), the apparatus #1 proceeds to the process of S23. In the process of S23, the apparatus #1 displays the advertisement information relevant to the new store or the like to which the preference information is given, on the display apparatus (display unit 204B) disposed at the back portion of the vehicle. After the process of S23, the apparatus #1 proceeds to the process of S24.

On the other hand, if the advertisement information, to which the preference information is given, is absent (S22, “No”), the apparatus #1 proceeds to the process of S24. In the process of S24, the apparatus #1 displays the advertisement information having no preferential designation (no preference information is given), on the display apparatus disposed at the back portion of the vehicle.

If the chasing vehicle #2 is present in accordance with the processes from S23 to S24, the advertisement information of the new store or the like that opened within the predetermined period, in which the traveling history information recorded for the chasing vehicle #2 is reflected, is displayed preferentially as compared with the advertisement information relevant to the user attribute information. On the other hand, if the chasing vehicle #2 is not present, the advertisement information of the new store or the like existing within the predetermined range with respect to the traveling position of the preceding vehicle #1 is displayed preferentially as compared with the advertisement information in the display period of the area ID including the traveling position of the preceding vehicle #1 in the area.

Note that as for the display of the advertisement information, the apparatus #1 may execute the processes from S23 to S24 on condition that the speed of the subject vehicle is lower than a previously set threshold value (for example, 20 km/h). It is possible to provide the advertisement information while considering the safety in relation to the traveling of the chasing vehicle #2 which chases the subject vehicle. The process illustrated in FIG. 11 is terminated after the process of S24, and the process illustrated in FIG. 9 is terminated.

According to the process as described above, in the advertisement system 1 concerning this embodiment, the server 10 can extract the advertisement information of the store or the like which newly opened within the predetermined period, on the basis of the store opening information for indicating the timing at which the provision of the merchandise, the service or the like of the store or the like was started, and the server 10 can register the advertisement information in the new information DB 16. Then, the server 10 can make reference, for example, to the new information DB 16, and the server 10 can select the advertisement information of the store or the like which newly opened within the predetermined range with respect to the traveling position acquired from the vehicle V1. The server 10 can give the preference information (designation of the preferential display) to the selected advertisement information in order to preferentially display the selected advertisement information as compared with any other advertisement information, and the server 10 can deliver the information to the vehicle V1. The vehicle V1 can preferentially display the advertisement information of the store or the like which newly opened within the predetermined period with respect to the outside of the vehicle as compared with any other advertisement information, in accordance with the preference information given to the advertisement information. According to this embodiment, it is possible to provide the advertisement information relevant to the store or the like which newly opened, while enhancing the advertisement effect thereof.

In the advertisement system 1 according to this embodiment, the server 10 can acquire the history information relevant to the traveling (for example, destination history, traveling track) from the chasing vehicle #2 which chases the preceding vehicle #1. Then, the server 10 can select the advertisement information relevant to the store or the like which newly opened, while reflecting the history information. According to this embodiment, it is possible to provide the advertisement information relevant to the store or the like which newly opened and which has not been visited by the user of the chasing vehicle yet.

### First Modified Embodiment

In an advertisement system 1 according to a first modified embodiment, the chasing vehicle #2 plays a major role to display the advertisement information relevant to the store or the like which newly opened, on the display apparatus provided at the back portion of the vehicle of the preceding vehicle #1.

The apparatus #2 of the first modified embodiment transmits the history information relevant to the traveling, the apparatus ID of the apparatus #1 carried on the preceding vehicle #1, and the position information to the server 10, for example, taking the opportunity of the acquisition of the position information of the subject vehicle (chasing vehicle #2) after establishing the inter-vehicle communication with respect to the preceding vehicle #1. Further, the apparatus #2 transmits, to the server 10, the information (identifier) for indicating that the subject vehicle is the chasing vehicle #2 which chases the preceding vehicle #1, and the apparatus ID of the subject apparatus.

The server 10 of the first modified embodiment acquires the foregoing information transmitted from the apparatus #2 via the network N1. Then, the server 10 of the first modified embodiment specifies that the apparatus #2 is the vehicle onboard apparatus carried on the chasing vehicle #2 which chases the preceding vehicle #1, on the basis of the identifier. The server 10 of the first modified embodiment executes the process illustrated in FIG. 10 on the basis of the position information and the history information relevant to the traveling transmitted from the apparatus #2, and the server 10 of the first modified embodiment selects the advertisement information to be delivered to the preceding vehicle #1 (S12 to S1B). The selected advertisement information is transmitted to the network N1 while using the apparatus ID of the apparatus #1 carried on the preceding vehicle #1 as the destination or address.

The apparatus #1 of the first modified embodiment executes the process illustrated in FIG. 11 on the basis of the advertisement information delivered from the server 10. Also in the form of the first modified embodiment, the advertisement system 1 can provide the advertisement information relevant to the store or the like which newly opened, while enhancing the advertisement effect of the advertisement information.

### Second Modified Embodiment

An advertisement system 1 of a second modified embodiment has such a form that the destination information relevant to the destination and the whereabouts information such as the route information or the like to arrive at the destination are acquired from the chasing vehicle #2, and the advertisement information relevant to the store or the like that newly opened, which is adapted to the whereabouts information, is displayed on the preceding vehicle #1.

The apparatus #1 of the second modified embodiment acquires, for example, the destination information relevant to the destination of the chasing vehicle #2 and the route information or the like to arrive at the destination, from the apparatus #2, and the information is transmitted to the server 10 together with the apparatus ID of the apparatus #2. Further, the apparatus #1 acquires the position information of the subject vehicle (preceding vehicle #1), and the information is transmitted to the server 10. The apparatus #1 of the second modified embodiment may acquire the destination information relevant to the destination of the chasing vehicle #2 and the whereabouts information such as the route information or the like to arrive at the destination, from the apparatus #2, for example, in accordance with the processes which are the same as or equivalent to those of the procedure (S1 to S6) for acquiring the traveling history information as illustrated in FIG. 9, and the information may be transmitted to the server 10.

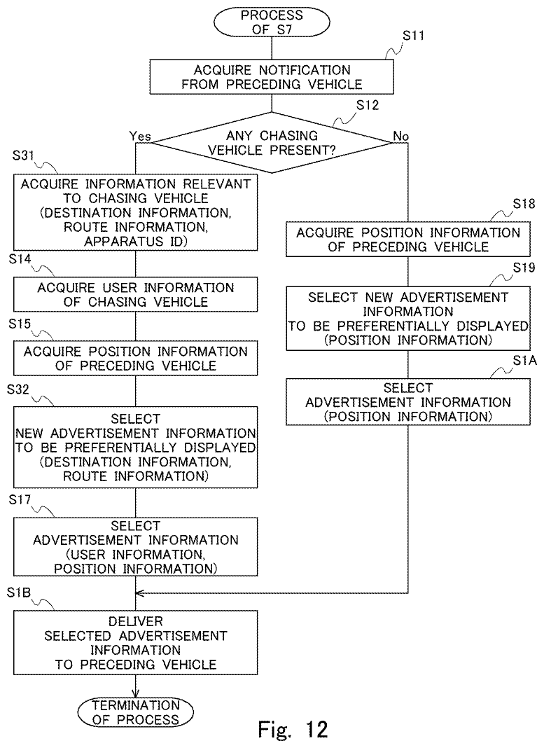

If the server 10 of the second modified embodiment accepts the whereabouts information of the chasing vehicle #2 via the network N1, the server 10 executes the process illustrated in FIG. 12 to select the advertisement information to be delivered to the preceding vehicle #1. FIG. 12 illustrates a flow chart illustrating a detailed exemplary process of S7 in the second modified embodiment. The process of the second modified embodiment illustrated in FIG. 12 is different from the process of the first embodiment in that processes of S31 and S32 are executed in place of the processes of S13 and S16 illustrated in FIG. 10. Different features will be principally explained below.

In the process of S31 illustrated in FIG. 12, the server 10 acquires the information relevant to the chasing vehicle #2 including the whereabouts information (for example, destination information, route information) of the chasing vehicle #2 and the apparatus ID of the apparatus #2. Then, in the process of S32, the server 10 selects the new advertisement information to be preferentially displayed, on the basis of the whereabouts information of the chasing vehicle #2 and the position information of the preceding vehicle #1.

The server 10 makes reference, for example, to the new information DB 16 to select the advertisement information relevant to the store or the like which started the provision of the merchandise, the service or the like in the predetermined period, in the area designated by the destination information. Similarly, the server 10 selects the advertisement information relevant to the store or the like which started the provision of the merchandise, the service or the like in the predetermined period existing in the predetermined range on the route designated by the route information. The preference information (identifier to indicate the preferential designation), which is provided to display the selected advertisement information preferentially as compared with any other advertisement information, is given by the server 10 to the selected advertisement information, and the information is delivered to the process of S1B. In the process of S1B of the second modified embodiment, the advertisement information relevant to the new store or the like, to which the preference information is given and which is selected on the basis of, for example, the destination information relevant to the destination of the chasing vehicle #2 and the route information to arrive at the destination, is delivered to the preceding vehicle #1 in the same manner as in FIG. 10.

The apparatus #1 of the second modified embodiment executes the process illustrated in FIG. 11 on the basis of the advertisement information delivered from the server 10. In the form of the second modified embodiment, the advertisement information relevant to the store or the like that newly opened, which is adapted to the whereabouts information such as the destination information, the route information and the like of the chasing vehicle #2, can be continuously provided to the user by the advertisement system 1. Note that in the second modified embodiment, it is also possible to apply the form of the first modified embodiment, i.e., the form in which the chasing vehicle #2 plays the major role to display the advertisement information relevant to the store or the like which newly opened, on the display apparatus provided at the back portion of the vehicle of the preceding vehicle #1.

### Other Embodiments

The foregoing embodiment has been described by way of example in every sense. The present disclosure can be carried out while being appropriately changed within a range without deviating from the gist or essential characteristics thereof. The processes and the means explained in this disclosure can be carried out while freely combining them unless any technical contradiction or inconsistency arises.

Further, the process, which has been explained as being performed by one apparatus or device, may be executed by a plurality of apparatuses or devices in a shared manner. Alternatively, the process, which has been explained as being performed by the different apparatuses or devices, may be executed by one apparatus or device without causing any problem. In the computer system, it is possible to flexibly change the way of realization of the respective functions by means of any hardware configuration (server configuration).

A program, which allows the information processing apparatus or any other machine, apparatus, or device (hereinafter referred to as “computer or the like”) to realize any one of the functions described above, can be recorded on a recording medium which can be read by the computer or the like. Then, it is possible to provide the function by allowing the computer or the like to read and execute the program on the recording medium.

In this context, the recording medium, which can be read by the computer or the like, refers to a recording medium on which the information of the data, the program or the like can be accumulated in accordance with the electric, magnetic, optical, mechanical, or chemical action, and the information can be read from the computer or the like. Those included in the recording medium as described above, which can be removed from the computer or the like, include, for example, flexible disk, magneto-optical disk, CD-ROM, CD-R/W, DVD, Blu-ray Disc, DAT, 8 mm tape, and memory card such as flash memory or the like. Further, the recording medium, which is fixed to the computer or the like, includes, for example, hard disk and ROM.

What is claimed is:

1. An information processing apparatus comprising a controller comprising at least one processor configured to execute:
acquisition of advertisement information relevant to a first store which started provision of a service in a predetermined period; and
display of the advertisement information of the first store while giving preference thereto as compared with advertisement information relevant to a second store other than the first store, on a display unit which is provided on a first vehicle and which displays information with respect to outside of the first vehicle.

2. The information processing apparatus according to claim 1, wherein the controller further executes:
acquisition of history information relevant to traveling of a second vehicle which chases the first vehicle; and
display of advertisement information relevant to a third store having no record remaining in the history information relevant to the traveling of the second vehicle, while giving preference thereto as compared with the advertisement information relevant to the second store, the third store being included in a plurality of the first stores.

3. The information processing apparatus according to claim 1, wherein the controller further executes:
acquisition of destination information relevant to a destination and route information relevant to a route until arrival at the destination of a second vehicle which chases the first vehicle; and
display of advertisement information relevant to a fourth store in relation to the destination information and the route information, while giving preference thereto as compared with the advertisement information relevant to the second store, the fourth store being included in a plurality of the first stores.

4. An information processing method comprising:
acquiring advertisement information relevant to a first store which started provision of a service in a predetermined period; and
displaying the advertisement information of the first store while giving preference thereto as compared with advertisement information relevant to a second store other than the first store, on a display unit which is provided on a first vehicle and which displays information with respect to outside of the first vehicle.

5. A non-transitory storage medium stored with a program for allowing a computer to execute:
acquisition of advertisement information relevant to a first store which started provision of a service in a predetermined period; and
display of the advertisement information of the first store while giving preference thereto as compared with advertisement information relevant to a second store other than the first store, on a display unit which is provided on a first vehicle and which displays information with respect to outside of the first vehicle.
